(19) United States
(12) Patent Application Publication
(10) Pub. No.: US 2005/0067555 A1
(43) Pub. Date: Mar. 31, 2005

(54) Standalone gradient detector

(75) Inventors: James E. Roberts, New Castle, IN (US); Michael W. Zollers, Fishers, IN (US); Bo J. Stout, Indianapolis, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, A Delaware Corporation, Pendleton, IN (US)

(21) Appl. No.: 10/670,905

(22) Filed: Sep. 25, 2003

(51) Int. Cl. G01J 1/42

(52) U.S. Cl. 250/208.2

(57) ABSTRACT

A standalone gradient detector system, utilizing a gradient detector with a several photodetectors, is disclosed. A lamp emits light toward a screen. The light strikes the photodetectors on a photodector array, which communicate the light intensity to a gradient circuit. The gradient circuit compares the intensity values from each photodetector with the intensity value for the photodetector immediately adjacent, and computes a gradient value. The maximum gradient value is displayed using a display device, and the position of the photodetector with the maximum gradient value is indicated by an adjacent light source. The gradient of an automobile headlamp may thus be found easily, assisting in headlamp positioning during headlamp and vehicle manufacture.

### BACKGROUND

Automobile headlamps are aimed on the vehicle near the end of the vehicle manufacturing process to ensure that the light beams emitted from the headlamp will be properly positioned with respect to the vehicle. Proper aim of the headlamps is important, as the headlamps must illuminate large portions of the roadway for the driver, but avoid glare in the eyes of oncoming traffic. One import criteria in aiming headlamps is measurement of the gradient of the beam pattern near the horizon. Headlamp manufacturers use a similar process to test new lamp designs and correct errors in the reflector before wide-scale manufacturing.

The gradient, in the instance of headlamp aiming and manufacture, is a measure of the change of the light intensity between two or more points from the center of the beam to the vertical limits of the beam. The center of the headlamp beam is ideally positioned to project light onto the road surface. Light incident to the main beam, or any light located above the horizon (assuming a flat driving plane), may cause glare light for oncoming drivers. Therefore, it is desirable for a large amount of light to be directed just below the horizon (and on the road) and very little light to be directed just above the horizon (in the face of oncoming traffic). Accordingly, it is desirable for the largest light gradient to be found at or near the horizon.

A gradient calculation requires at least two measurements of light intensity in two different places on the beam pattern. Typically, this is accomplished by using a single fixed intensity detector, or photodetector, and subsequently moving the headlamp through the use of a gonio-photometer system. The value of the maximum gradient, and the position of the maximum gradient on the beam pattern, are determined through the use of an external software-driven computer system that interprets the intensity values of the detector and calculates the gradient between any two detector readings. This process, including the use of the gonio-photometer system to move the headlamp, is time consuming. The process is especially time consuming during headlamp manufacture, when many small changes are typically made to the headlamp reflector or other geometries.

A desirable feature of a gradient detector would be the inclusion of a plurality of photodetectors. A system utilizing a plurality of photodetectors would be operable to sample the light intensity from several points on the headlamp beam simultaneously, and then compute and locate the maximum gradient value. Such a system would greatly increase the speed and efficiency of measuring the gradient of the beam pattern by providing nearly instantaneous feedback regarding the location and value of the maximum light gradient. The prompt feedback would be especially helpful when manufacturing headlamps, as changes could be made to the headlamp much more quickly, without the delay of the gonio-photometer system. The prompt feedback would also be helpful when aiming headlamps during the manufacturing process, as adjustments to the aim of the headlamp could be made based on the location of the maximum gradient value.

### SUMMARY

A light beam gradient detector comprises a photodetector array positioned in front of a light beam. The photodetector array includes a plurality of photodetector elements each operable to provide a signal that corresponds to the light received by photodetector element. A gradient circuit is in communication with the photodetector array and operable to determine a light gradient measured between two adjacent photodetector elements. The gradient circuit is further operable to determine the maximum light gradient of all the measured light gradients. A display device is in communication with the gradient circuit and operable to display the value of the maximum measured light gradient near the location of the photodetector array. A plurality of light sources are also provided in association with the photodetector array. Each of the plurality of light sources is positioned adjacent to one of the plurality of photodetector elements. To indicate the location of the maximum measured light gradient, one of the plurality of light sources is illuminated when the maximum measured light gradient is displayed. The light beam gradient detector, including photodetector array, associated light sources and display device may be a free-standing unit or may alternatively be mounted on a screen or a wall, such as a wall having markings representative of a roadway.

### BRIEF DESCRIPTION OF THE DRAWINGS

FIG. 1 is a front perspective view of a gradient detector system;

FIG. 2 is a component view of the gradient detector as shown in FIG. 1;

FIG. 3 is a side view of the gradient detector system as shown in FIG. 1; and

FIG. 4 is a block diagram overview of the electrical components included in the gradient detector system.

### DETAILED DESCRIPTION

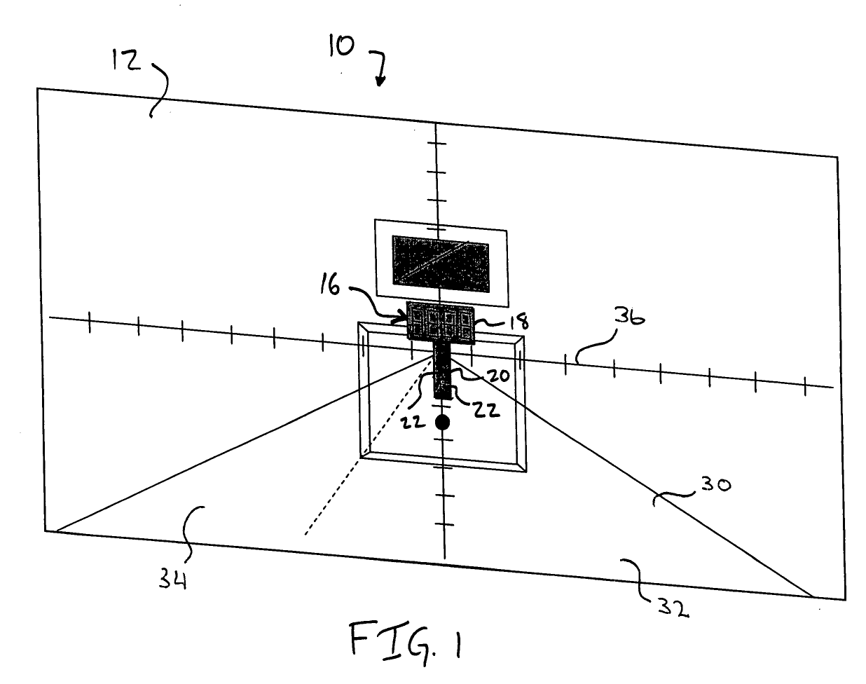

One embodiment of a standalone light beam gradient detector is provided as shown in FIG. 1, and is generally indicated as numeral 12. The standalone gradient detector 10 comprises a gradient detector 16 suspended by a support device 12 to allow the gradient detector to receive light emitted from a vehicle lamp. The gradient detector 16 is comprised of a display device 18, a photodetector array 20, and a plurality of light sources 24. The photodetector array 20 includes a plurality of photodetectors 22 arranged in a vertical column, with the plurality of light sources 24 adjacent to the photodetectors 22.

The support device 12 may take a number of different forms. For example, the support device may be a tripod, pole, or other device that properly positions the gradient detector 16 in the air to receive light from the lamp. Alternatively, the support device 12 may be a screen having a plurality of markings thereon. The screen 12 may be positioned on a fixed structure or portable. For example, the screen may be attached to or part of a wall, or the screen may be attached to a moveable screen stand, as is well known in the art, to increase portability. The markings on the screen 12 are representative of a roadway 30 and a flat horizon 36. The roadway 30 includes a driver's lane 32 and an oncoming traffic lane 34. The markings on the screen are used to adjust the beam pattern of an automobile headlamp so that it conforms to the desired shape, size and direction. The markings are well known and practiced in the art.

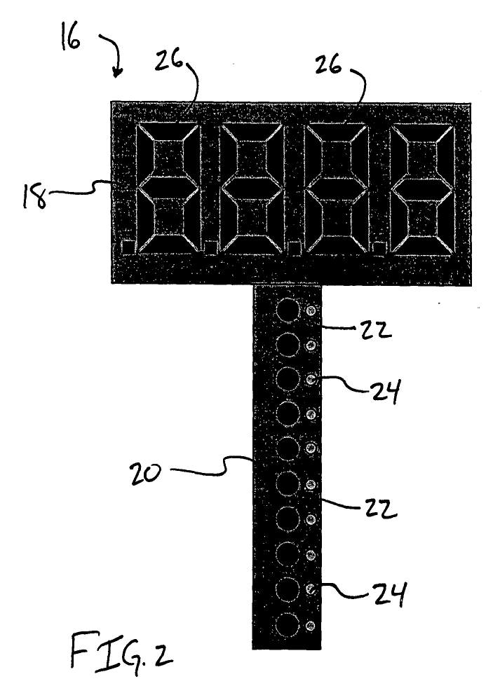

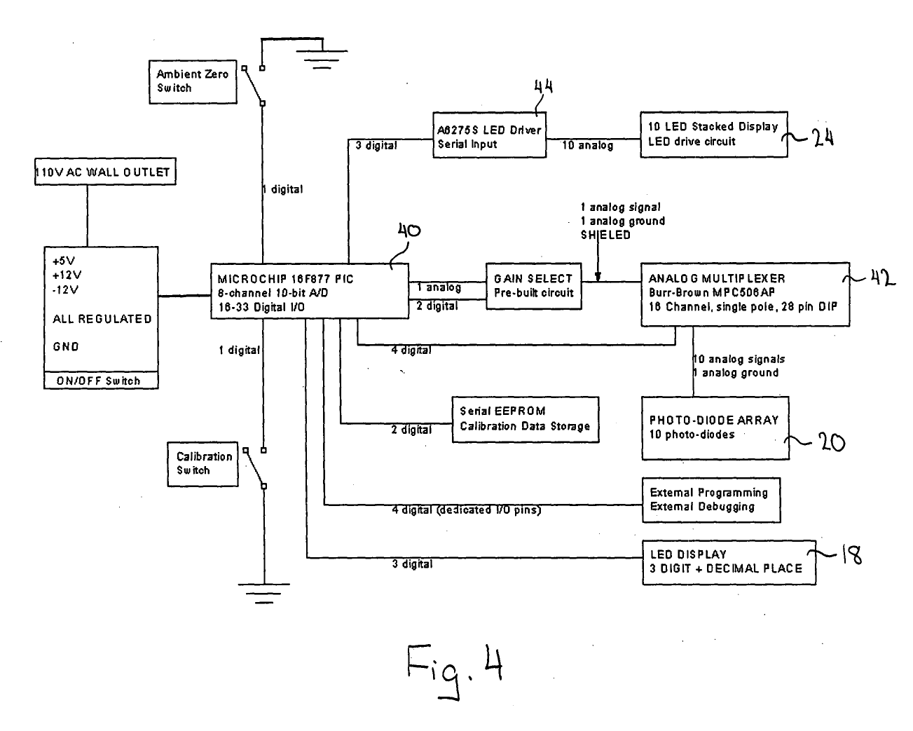

Referring now to FIG. 1, the gradient detector 16 is attached to the screen 12. The gradient detector 16 is positioned near the center of the screen 12, with the photodetector array 20 positioned vertically. As shown in FIG. 2, the gradient detector 16 is comprised of a photodetector array 20 including a plurality of adjacent photodetectors 22, each in electrical communication with a gradient circuit 40 (see FIG. 4). The gradient detector also comprises a plurality of light sources 24 associated with each of the photodetectors 22 and a display device 18. The light sources 24 and display device 18 are both in electrical communication with the gradient circuit.

The display device 18 comprises an LED display including a plurality of individual number displays 26. As shown in FIG. 2, four individual number displays 26 are shown. The individual number displays 26 are operable to display a full range of alphanumeric characters. Of course, alternate embodiments may include any number of individual number displays 26 attached to the display device 18, or may include a cathode-ray tube (“CRT”) screen 12, liquid crystal display, or an array of light emitting diodes, operable to display a plurality of alphanumeric characters. Each of the individual number displays 26 is in electrical communication with the gradient circuit 40.

The photodetector array 20 is comprised of a plurality of photodetectors 22. A plurality of light sources 24 are positioned next to the plurality of photodetectors. The photodetectors 22 are positioned in a substantially straight vertical line on the photodetector array 20, and are spaced equally apart on the array. Each of the photodetectors is capable of providing a signal related to the light received by the photodetector. For example, each of the photodetectors may provide a signal that corresponds to the intensity of light at the photodetector. Adjacent to each of the photodetectors 22 is a corresponding light source 24, such that an equal number of photodetectors 22 and light sources 24 are present on the gradient detector 16. The light sources 24 may be light emitting diodes or any other light source as commonly used to indicate a particular location. Each of the plurality of photodetectors 22 and light sources 24 is in electrical communication with the gradient circuit.

As shown in FIG. 4, the gradient circuit 40 is an electrical circuit, such as a software controlled microchip. Of course, the gradient circuit could be comprised solely of hardware devices. The gradient circuit 40 may be located within the gradient detector 16, or may be located separately. The gradient circuit 40 is in electrical communication with the photodetectors 22 on the photodetector array 20, the display device 18, and the light sources 24. Through a multiplexer 42, the gradient circuit receives electrical signals from each of the plurality of photodetectors 22 attached to the photodetector array 20, and converts each of the electrical signals into a discrete intensity value. The gradient circuit then compares the values to determine the location of the largest light gradient in the array 20. The microchip 40 instructs the LED display 18 to display the value of the largest light gradient, and the microchip also provides a signal to a LED driver 44 that lights the LED in the LED array that is associated with the largest gradient value.

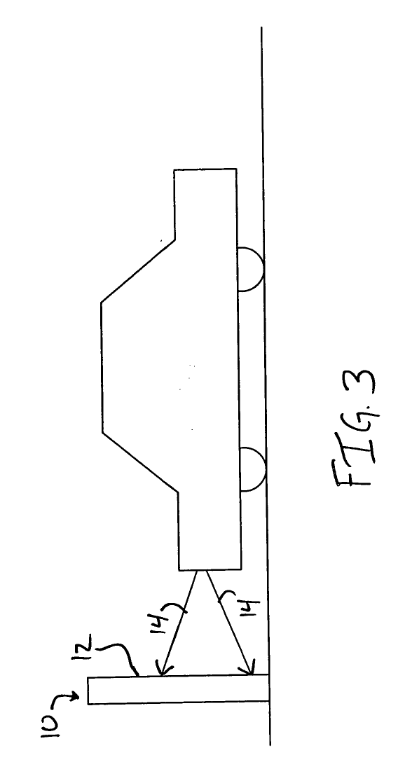

Operation of the disclosed embodiment of a standalone light beam gradient detector 10 is now described as shown in FIGS. 1-3. With reference to FIG. 3, an automobile is positioned at a pre-selected distance from the standalone light beam gradient detector 10. Alternatively, an automobile headlamp may be positioned at a distance from the standalone light beam gradient detector 10, if the headlamp is to be tested and measured apart from the automobile. The automobile headlamp is illuminated, and projects light 14 onto the gradient detector 16 and associated screen 12 or other support device. Light 14 from the lamp strikes the screen 12, and the photodetector array 20 of the gradient detector 16. Referring also to FIG. 2, light thus strikes each of the plurality of photodetectors 22, which individually transmit intensity information to the gradient circuit 40. The gradient circuit 40 compares the intensity value from each of the photodetectors 22 with the intensity value received from the immediately adjacent photodetector, and calculates a gradient value for each of the plurality of photodetectors 22. The gradient circuit 40 transmits the largest gradient value calculated to the display device 18 for display using the plurality of individual number displays 26. The gradient circuit 40 also energizes the light source 24 adjacent to the photodetector with the largest gradient value, providing a visual indication of the location of the largest gradient value. The gradient circuit 40 may be operable repeat the process of collecting intensity values from the photodetectors 22 and displaying the maximum gradient value over any frequency, including several times a second. The standalone light beam gradient detector may also be triggered to operate as described above by a switch or other means.

With the position of the maximum gradient detected, the headlamp may be adjusted to better position the light beam emitted from the headlamp with respect to the horizon. Also, if the headlamp is being tested for conformity with certain specifications, locating the maximum gradient value will assist in completing the test and determining whether changes need to be made in the headlamp. If the gradient circuit includes a software program having a user interface, the display device may be used to display other information in addition to the maximum gradient value. For example, the intensity of the light beam at any of the plurality of photo detectors 22 may be displayed on the display device 18. This will further assist the user in testing the headlamp for conformity with certain specifications.

While the above operation has been described with respect to one embodiment of the standalone gradient detector, it should be understood that the functions and features of the gradient detector 16 may vary. For example, the gradient detector 16 and the gradient circuit 40 may be operable to display the smallest gradient value obtained from the plurality of photodetectors 22, along with the light source adjacent to the photodetector with the smallest gradient value. Further, an alternate embodiment may display the average gradient value from the photodetector array 20, or any other desirable data as obtained from the plurality of photodetectors 22. As another example, the plurality of light sources may be associated with and positioned adjacent to the photodetectors in a location that is in-between each of the plurality of photodetectors as opposed to directly beside any one photodetector.

Although other advantages may be found and realized and various modifications may be suggested by those versed in the art, it is understood that the present invention is not to be limited to the details given above, but rather may be modified within the scope of the appended claims.

1. A light beam gradient detector comprising:
a. a photodetector array having a plurality of photodetector elements each operable to provide a signal that corresponds to the light received by photodetector element;
b. a gradient circuit in communication with the photodetector array and operable to determine a light gradient measured between two of the plurality of photodetector elements; and
c. a display device in communication with the gradient circuit and operable to display the value of the light gradient measured between two of the plurality of photodetector elements.

2. The light beam gradient detector of claim 1, wherein the photodetector array further comprises a plurality of light sources, each of the plurality of light sources positioned adjacent to one of the plurality of photodetector elements, at the plurality of light sources in communication with the gradient circuit.

3. The light beam gradient detector of claim 1 wherein the plurality of photodetector elements comprise at least three photodetectors.

4. The light beam gradient detector of claim 1 wherein the gradient circuit comprises a microchip.

5. The light beam gradient detector of claim 1 further comprising a mounting device, wherein the gradient circuit is attached to the mounting device.

6. The light beam gradient detector of claim 5 wherein the mounting device is a screen.

7. The light beam gradient detector of claim 6 wherein the screen is attached to a wall.

8. The light beam gradient detector of claim 6 wherein the screen includes a plurality of markings.

9. A light beam gradient detector comprising:
a. a mounting device;
b. a photodetector array positioned upon the mounting device, the photodetector array having a plurality of adjacent photodetector elements;
c. a gradient circuit in communication with the plurality of photodetector elements, the gradient circuit operable to determine a light gradient between two of the plurality of adjacent photodetector elements, and
d. a plurality of light sources also positioned upon the mounting device, each of the plurality of light sources adjacent to one of the plurality of photodetector elements, wherein one of the plurality of light sources is illuminated to indicate the location of the light gradient determined by the gradient circuit.

10. The light beam gradient detector as in claim 9 further comprising a display device positioned upon the mounting device and operable to display a value for the light gradient determined by the gradient circuit.

11. The light beam gradient detector of claim 9 wherein the gradient circuit is operable to collect intensity values from each of the plurality of photodetector elements and determine the light gradient between each of the plurality of photodetector elements.

12. The light beam gradient detector of claim 9 wherein the gradient circuit is operable to determine the maximum light gradient for all light gradients determined between adjacent photodetector elements.

13. The light beam gradient detector of claim 9 further comprising a display device in communication with the gradient detector and operable to display a value for a maximum light gradient determined by the gradient circuit.

14. The light beam gradient detector of claim 9 wherein the gradient circuit comprises a microchip.

15. The light beam gradient detector of claim 9 wherein the mounting device is a screen.

16. The light beam gradient detector of claim 15 wherein the screen includes a plurality of markings representative of a roadway.

17. The light beam gradient detector of claim 16 wherein the screen includes at least one marking representative of a horizon.

18. A light beam gradient detector comprising:
a. a screen for receiving at least one beam of light;
b. means for determining a maximum gradient value of light projected onto the screen; and
c. means for displaying the position of the maximum gradient on the screen.

19. The light beam gradient detector of claim 18 further comprising means for displaying the maximum gradient value.

20. The light beam gradient detector of claim 19 wherein the means for displaying the maximum gradient value is located on the screen.
